(19) United States
(12) Patent Application Publication
(10) Pub. No.: US 2012/0005474 A1
(43) Pub. Date: Jan. 5, 2012

(54) INFORMATION SYSTEM AND METHOD OF IDENTIFYING A USER BY AN APPLICATION SERVER

(75) Inventors: Dominique Bourret, Sonnaz (FR); Jérémie Nowak, Bourg Les Valences (FR)

(73) Assignee: FIDALIS, SONNAZ (FR)

(21) Appl. No.: 12/672,632

(22) PCT Filed: Aug. 7, 2008
(86) PCT No.: PCT/EP2008/060371

§ 371 Date: Feb. 8, 2010

(30) Foreign Application Priority Data
Aug. 8, 2007 (FR) 07/05763

(51) Int. Cl. H04L 9/32

(52) U.S. Cl. 713/150

(57) ABSTRACT

The present invention relates to an information system and a method for the identification, by an application server (2), of a user in possession of a terminal (6) having the use of communication means for effecting a connection between the server (2) and the terminal (6) and of a hardware element (8), connected to the terminal (6), comprising data storage means on which is stored an encrypton key (K1) and an identification number (num_ID), in which the server (2) generates a unique session number (num_Sess) in the course of a connection session between the terminal (6) and the server (2), the terminal communicates the session number (num_Sess) to the hardware element (6), the hardware element (6) effects an encryption (E) with the aid of an encryption key (K1) of a data set combining: the password (num_MDP) and the session number (num_Sess), and communicates the result (C) of the encryption to the terminal (6), the hardware element (8) also transmits the identification number (num_ID) to the terminal (6), the terminal (6) transmits the result of the encryption (C) and the identification number (num_ID) to the server (2) with a view to carrying out the identification of the user.

### TECHNICAL FIELD

The present invention relates to an information system and a method for identifying a user accessing an information system.

### BACKGROUND

When a user uses a computer to access a service on a communication network, for example the Internet, hosted by a computer server, it is desirable for the server to be able to identify this user. It is in particular desirable for the server to be able to know that it is not an automatic program trying to pass itself off as a user.

This problem arises, for example, when consulting email on the Internet and when registering an order on a shopping site.

For this identification, it is known to use passwords. Thus, the user must input a password and the server in response confirms whether this password is correct. The user and the server both know this secret information and the server asks for it each time a user wants to access a service.

However, if a third party has access to the information on the server and obtains the list of passwords, the security of the system is compromised. Furthermore, access to the password may be possible by a third party on the user's computer. In practice, the passwords that must be retained by the user are often stored on his computer, for example in an Internet browser.

Furthermore, some passwords are transmitted as plaintext.

It should be noted that it is possible to circumvent the storage of the passwords on the server. In practice, the server does not need to store the passwords: it simply needs to be able to distinguish a correct password. The server uses, for example, a one-way function that is applied to the password. The result of the function on a particular password is stored. Upon each identification:
the password is presented to the server,
the server applies the one-way function to the password, and
the server compares the result of this calculation to that which it has in memory to identify the user.

The list of the results of the application of the one-way function to the passwords cannot be used because this function has the property of being very difficult to reverse.

This protocol is known to have important security failings. In practice, when the password is presented to the system which transmits it to the server, any person who has access to the data over the link between the input point and the server can read it.

Known software means, in particular such as HTTPS and SLL/SSH or virtual private networks, can be used to secure the transfer of the data from the user's computer to the server. However, these means do not allow for the user to be authenticated.

It is also known to use public key/private key or secret key cryptography mechanisms.

In the secret key mechanism, an exchange of secret keys is carried out by using pairs of public and private keys. The secret key has a usage duration that is limited to the session and is used to encrypt data. The main disadvantage of the secret key mechanisms is that the same key is manipulated by both parties. If one of them is broadcast, the security of the system is compromised.

Public key/private key cryptography solves this problem. The server manages a file containing the public keys of each user. Each user has a private key. The session opening protocol proceeds as follows:

1. The server sends a randomly or pseudo-randomly generated session number.

2. The user encrypts this number with his private key and sends the result with his identification number to the server.

3. The server uses the public key of the user which is in the database and decrypts the message.

4. If the result obtained is the same as the one the server has sent, the server knows that it is indeed the user identified by the identification number.

If the private key of the user remains confidential, no-one can pass themselves off as that user. The user never transmits his private key when connecting to the server. No-one can obtain information enabling him to determine the private key of the user. This technique uses a private key which can be long and difficult for the user to memorize. This private key will be manipulated by the user's software and hardware.

In these conditions, neither the server, nor the communication channel between the user's computer, needs to be safe.

It appears however that the personal computer or the terminal used by the user to connect to the communication network must be secured, because this computer manipulates the private key.

Furthermore, there are possibilities for the private key to be discovered by a third party implementing an algorithm based on the use of random numbers.

### BRIEF SUMMARY

The aim of the disclosure is to resolve all or some of the drawbacks mentioned hereinabove by providing a system making it possible to reinforce security in the identification of a user without requiring the user's terminal to be secured.

To this end, the disclosure provides an information system comprising:
a computer server comprising networked communication means,
at least one terminal comprising networked communication means, the terminal being intended to be used by a user to set up a connection to the server, characterized in that

the system also includes a hardware element arranged to be connected to the terminal, the hardware element comprising data storage means arranged to store an encryption key and an identification number,

in that

the server is arranged to generate a unique session number in the course of a connection session between the terminal and the server, and to communicate the session number to the terminal, the terminal being arranged to communicate the session number to the hardware element

and in that

the hardware element comprises processing means arranged to produce an encryption using an encryption key for a data set combining:
a password of the user, and
the session number,

and arranged to transmit the result of the encryption forming an encrypted password and the identification number to the terminal, the terminal being arranged to transmit the encrypted password and the identification number to the server in order to identify the user.

Thanks to the provisions according to the invention, a hardware element external to the terminal is used to present the user's password in a different form in each communication session, by using the uniqueness of the session numbers. The hardware element assigned to the user identifies him with the information system.

The messages containing the transmitted passwords will never be the same twice if the session numbers are different each time.

Thus, the information circulating over the information network is difficult to interpret because its content differs in each communication. Furthermore, no secret information is stored on the user's terminal. Consequently, the overall security of the system is enhanced.

According to one embodiment, the password is stored on the data storage means of the hardware element.

The hardware element is used to store a password outside the terminal, which reinforces the security of the system.

According to another embodiment, the terminal comprises means of inputting the password by the user and is arranged to communicate the password to the hardware element.

Advantageously, the server is arranged to communicate a unique session number in response to the provision of an identification number by the hardware element.

According to one embodiment, the server is arranged to produce an encryption by an encryption key of the session number into an encrypted session number and to communicate the encrypted session number to the terminal, the terminal being arranged to communicate the encrypted session number to the hardware element, the processing means of the hardware element being arranged to produce a decryption of the encrypted session number into a session number by the encryption key stored in the storage means.

Advantageously, the server is arranged to produce a decryption of the encrypted password using a decryption key corresponding to the encryption key stored in the storage means of the hardware element, to obtain the values of the password and of the session number.

According to one embodiment, the server is arranged to compare the session number originating from the encrypted password with that which it has generated, then to compare the result of the application of a hashing function to a data combination comprising the password with a predetermined value.

Advantageously, the password and the identification number form a unique information pair in the system.

Advantageously, the hardware element comprises means of generating a random sequence, the processing means being arranged to produce a first encryption of a data set combining:
the random sequence, and
the identification number of the user,

and arranged to transmit a first data frame comprising the result of the first encryption to the terminal, the terminal being arranged to transmit this first data frame to the server,

the server being arranged to produce the decryption of the first data frame then a second encryption of a data set combining:
the random sequence, and
a session number, and
an identification number of the server

and to transmit a second data frame comprising the result of this second encryption to the terminal, the terminal being arranged to transmit this second data frame to the hardware element.

These provisions make it possible to produce a mutual authentication of the server and of the user before transmitting critical data. Thus, the hardware element has the capacity to determine which recipient server the password is sent to. For this, it “challenges” the server, to determine whether it is connected to a determined server.

Preferentially, two pairs of private keys and public keys are used respectively for the encryption and the decryption of a first and a second data exchange between the server and the hardware element.

Advantageously, a number of random sequences and/or a number of session numbers are generated by the hardware element or the server for successive data exchanges to identify a user.

Preferentially, the means of generating a random sequence of the hardware element are arranged to take account of the occurrence of a random event. The random events taken into account by the random sequence generation means notably comprise interrupts signaling the arrival of new information at the hardware element originating from the terminal.

These provisions make it possible to generate random sequences from a simple hardware element, notably of USB key type, of which the behavior, and notably that of its microprocessor, is deterministic. The present invention also relates to a method of identifying, by a computer server, a user in possession of a terminal having communication means to set up a connection between the server and the terminal, and a hardware element, connected to the terminal, comprising data storage means on which are stored an encryption key and an identification number, wherein
the server generates a unique session number in the course of a connection session between the terminal and the server,
the terminal communicates the session number to the hardware element,
the hardware element produces an encryption using an encryption key of a data set combining the password and the session number, and communicates the result of the encryption to the terminal,
the hardware element also transmits the identification number to the terminal,
the terminal transmits the result of the encryption and the identification number to the server in order to identify the user.

According to one implementation of the method, the password is stored on the data storage means of the hardware element.

According to another implementation of the method, the password is input by the user on the terminal and communicated to the hardware element by the terminal.

Advantageously, the server communicates a unique session number in response to the provision of an identification number by the hardware element.

According to one implementation of the method, the server produces an encryption by an encryption key of the session number into an encrypted session number and communicates the encrypted session number to the terminal, the terminal communicating the encrypted session number to the hardware element, the processing means of the hardware element producing a decryption of the encrypted session number into a session number by the encryption key stored in the storage means.

Advantageously, the server produces a decryption of the encrypted password using a decryption key corresponding to the encryption key stored in the storage means of the hardware element, to obtain the values of the password and of the session number.

According to one implementation, the server compares the session number originating from the encrypted password with that which it has generated, then compares the result of the application of a hashing function to a data combination comprising the password with a predetermined value.

Advantageously, the password and the identification number form a unique information pair.

Advantageously, the hardware element generates a random sequence, produces a first encryption of a data set combining:
the random sequence, and
the identification number of the user,

and transmits a first data frame corresponding to the result of the encryption to the terminal which transmits this first data frame to the server,

the server producing a decryption of the first data frame then a second encryption of a data set combining:
the random sequence, and
a session number, and
an identification number of the server

and transmitting a second data frame corresponding to the result of this second encryption to the terminal, the terminal transmitting this second data frame to the hardware element.

Preferentially, two pairs of private keys and public keys are used respectively for the encryption and the decryption of a first and a second data exchange between the server and the hardware element.

Advantageously, a number of random sequences and/or a number of session numbers are generated for successive data exchanges to identify a user.

Preferentially, the generation of a random sequence takes account of the occurrence of a random event.

Advantageously, the random events taken into account when generating random sequences comprise interrupts signaling the arrival of new information at the hardware element originating from the terminal.

Preferentially, at least one data frame exchanged between the hardware element and the terminal comprises both a random sequence generated by the hardware element and a session number generated by the server.

### BRIEF DESCRIPTION OF THE DRAWINGS

In any case, the invention will be clearly understood from the following description, given with reference to the appended diagrammatic drawing which represents, by way of nonlimiting example, one embodiment of the system according to the invention.

FIG. 1 is a diagrammatic representation of a system according to the invention.

FIG. 2 is a diagrammatic representation of a first implementation of method according to the invention.

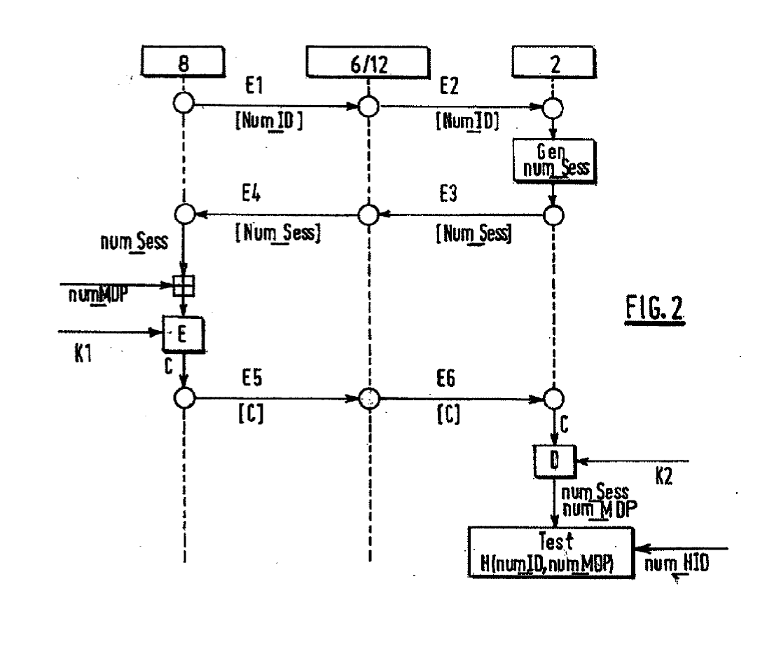

FIG. 3 is a diagrammatic representation of a second implementation of a method according to the invention.

FIG. 4 is a diagrammatic representation of a third implementation of a method according to the invention.

FIG. 5 is a diagrammatic representation of a fourth implementation of a method according to the invention.

FIG. 6 is a diagram explaining the operation of the means of generating a random sequence by a hardware element included according to a variant of the system according to the invention.

### DETAILED DESCRIPTION

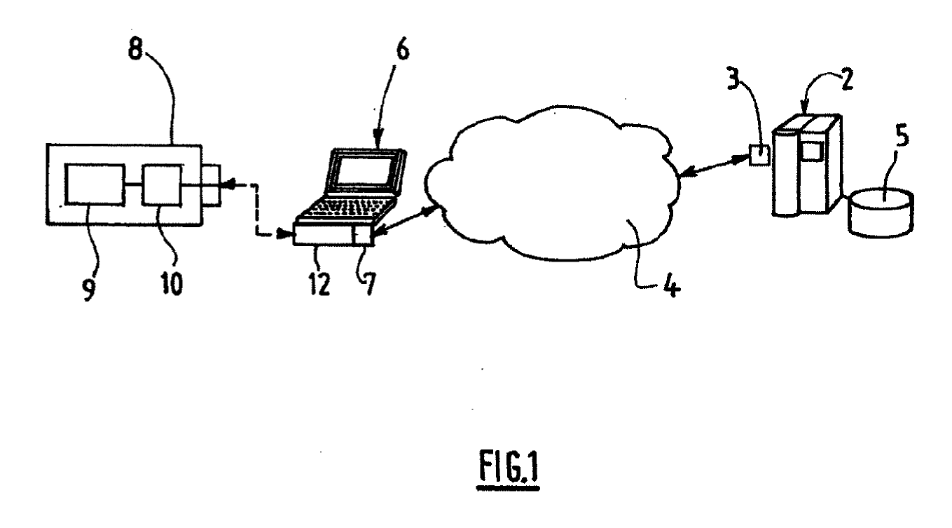

As represented in FIG. 1, an information system according to the invention comprises:
an application server 2 comprising networked communication means 3 enabling it to be connected to a network 4, and data storage means, for example a database 5,
at least one terminal 6 comprising networked communication means 7 making it possible to connect it to the network 4 intended to be used by a user.

The system further comprises a hardware element 8 arranged to be connected to the terminal, this element 8 being in the possession of the user.

The hardware element 8 can take the form of a USB key, a chip card or a processor that can be used to produce a barcode or electronic tag reader for example.

This hardware element 8 comprises data storage means 9, and processing means 10 arranged notably to carry out data encryption operations based on a secret private key K1.

The terminal 6 can, for example, comprise a personal computer of the user who has an Internet connection enabling him to connect to the application server. Client software 12 is installed on this computer which controls the exchanges between the hardware element, the computer and the server.

Before the hardware element 8 is supplied to the user, or in an operation to initialize the hardware element 8, a private key K1, a password num_MDP and an identification number num_ID are generated and stored in the storage means of the hardware element.

The identification number num_ID is a number that will be visible as plaintext in various operations. The password num_MDP is designed to remain secret.

The equipment carrying out this operation ensures that the public key K2 corresponding to the private key K1 of the user is stored by the server 2.

The password num_MDP and the identification number must be able to be recognized by the server 2. For this, by using a one-way hashing function H, an imprint num_HID, or hashing value of fixed length is calculated from the identification number concatenated with the password:
num_HID=H(num_ID; num_MDP).

The hashing function H has the property of making it difficult to calculate num_ID and num_MDP from the imprint. Furthermore, it is difficult to find another data set M′ such that num_HID=H(M′). The hashing function is used to check the validity of the password without having to store it.

The server 2 stores the num_HID and num_ID pair in the database 5.

The hardware element 8 is supplied to the user who can then connect it to a terminal 6 of his choice, with the client software 12 installed, to connect to the server 2.

When connecting to the server, the information system uses a password presentation protocol which observes the following steps:

In a first step E1, the hardware element 8 transmits its identification number num_ID to the client software 12 installed on the user's computer 6.

In a second step E2, the identification number num_ID is transmitted to the server 2 in a session number request.

In a third step E3, a session number num_Sess is generated by the server 2. The server 2 transmits this session number num_Sess to the user's computer 6. The server can also store the identification number num_ID of the user for which the session number num_Sess has been generated.

In a fourth step E4, the user's computer transmits the session number num_Sess to the hardware element 8.

In a fifth step E5, the processing means 10 of the hardware element 8 concatenate the password num_MDP and the session number num_Sess, then produce an encryption E using the private key K1, to obtain a result C:
E_{K1}(num_{—MDP; num}_Sess)=C

and sends the result C that we will call a signed password C to the client software 12.

In a sixth step E6, the client software 12 will transmit the signed password C in turn to the server 2.

Once the password presentation protocol is complete, the server 2 produces a decryption D of the signed password C using the public key K2 corresponding to the private key K1 of the user, which enables him to obtain the values of the password num_MDP and of the session number num_Sess:
D_{K2}(C)=num_{—MDP; num}_Sess

The server 2 then compares the session number num_Sess with the one that it has transmitted, then it calculates and compares the imprint H(num_ID, num_MDP) of the concatenation of the user identifier num_ID and of password num_MDP with the imprint num_HID stored in the database 5 corresponding to the identifier num_ID to accept or reject the identification of the user.

The method according to the invention therefore uses the session number num_Sess to mask the password num_MDP.

The hardware element 8 uses a private key K1 cryptography algorithm to authenticate, with the application server, the password num_MDP which correspond with the identification number num_ID assigned to a user.

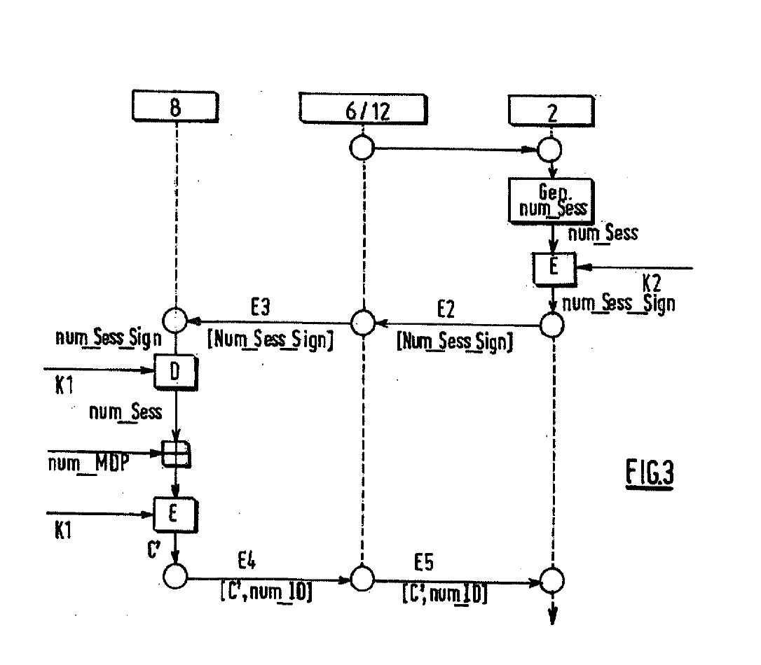

According to a second implementation of a method according to the invention represented in FIG. 3, it is also possible to implement a method wherein the server is authenticated with the hardware element in order to obtain the password. The server encrypts the session number that the hardware element will use to mask the password.

Thus, in a first step E1, a connection request is initiated by the user on the terminal which transmits this request to the server.

In a second step E2, the server produces an encryption of this session number num_Sess by the public key K2 of the user into an encrypted session number num_Sess_Sign:
num_Sess_Sign=E_{K2}(num_Sess).

The server transmits this encrypted session number num_Sess_Sign to the user's computer.

In a third step E3, the user's computer transmits the encrypted session number num_Sess_Sign to the hardware element.

In a fourth step E4, the hardware element produces a decryption D of the encrypted session number num_Sess_Sign to obtain the session number num_Sess using its private key K1:
num_Sess=D_{K1}(num_Sess_Sign)

Then, the processing means of the hardware element sign the password from the session number num_Sess, then produce an encryption E using their private key K1, to obtain a result C′:
E_{K1}(num_{—MDP); num}_Sess)=C′

and send the result C′ which corresponds to a signed password to the client software, accompanied by the identification number num_ID.

In a fifth step E5, the client software 12 transmits the signed password C′ and the identification number num_ID to the server 2.

The server then carries out the operations of decryption and of comparison with the stored imprint as in the first embodiment. The latter operations are not represented in FIG. 3.

It should be noted that the public key K2 remains secret. The private key K1 is used to transmit the response to the server.

Compared to the first implementation, it should be noted that the order of transmission of the identification number and of the session number is reversed.

According to a variant embodiment of the system represented in FIG. 1, the hardware element 8 comprises means of generating a random sequence or a random number Num_Alea.

The hardware element also stores two distinct private keys Ks1 and Ks2.

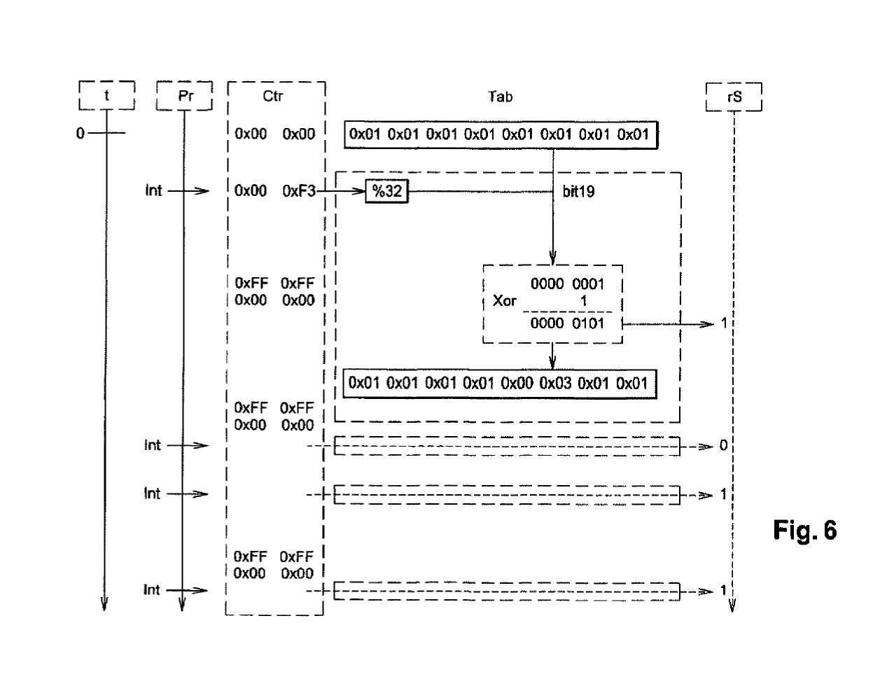

The operation of the generation means 13 is illustrated in FIG. 6.

The random sequence Num_Alea is generated by taking account of the occurrence of a random event.

In particular, such random events can comprise interrupts in signaling the arrival of new information at the hardware element 8 originating from the terminal 6.

As an example, in the case of the embodiment of the hardware element in the form of a USB key, such an interrupt is an interrupt in the USB protocol used between the terminal and the key.

The sequence of these events in time depends on the exchanges between two hardware entities, namely the hardware element 8 and the terminal 6 via a communication medium governed by a software protocol subject to physical constraints directly associated with the components that make up these entities.

The interaction between these elements constitutes a context that is difficult to reproduce, which makes it impossible to deduce the sequence of the events Int.

One example of determining the random sequence Num_Alea from the events Int is now described. The hardware element 8 is programmed to increment a counter Ctr in step with the frequency of its microprocessor from the moment when this element is powered up.

This counter Ctr is stored on a finite number of bits, for example 16 bits, which means that it is cyclical and that it will return to its initial state.

Each time an interrupt Int is received, the processing means 9 of the hardware element 8 are arranged to look up the current value of the counter Ctr.

An operation, for example of the Xor type, is then carried out between the value of the counter Ctr and a value extracted from a table of values Tab containing a data set of a size greater than that of the counter.

An event Int is used to modify the value of the pointer indicating where the value is extracted from the table Tab.

The data initially stored in the table Tab is kept secret.

The result of the operation between the value of the counter and the value extracted from the table is used to deduce a one-bit value, for example by an extraction or the application of a determined function.

The series of the bits obtained in this, way rS constitutes a random series from which a defined number of elements is retained in a rolling manner to form a random number or random sequence Num_Alea.

According to a variant, the occurrence of a random event is combined with a measured value of a complex physical phenomenon in order to reinforce the security of the system.

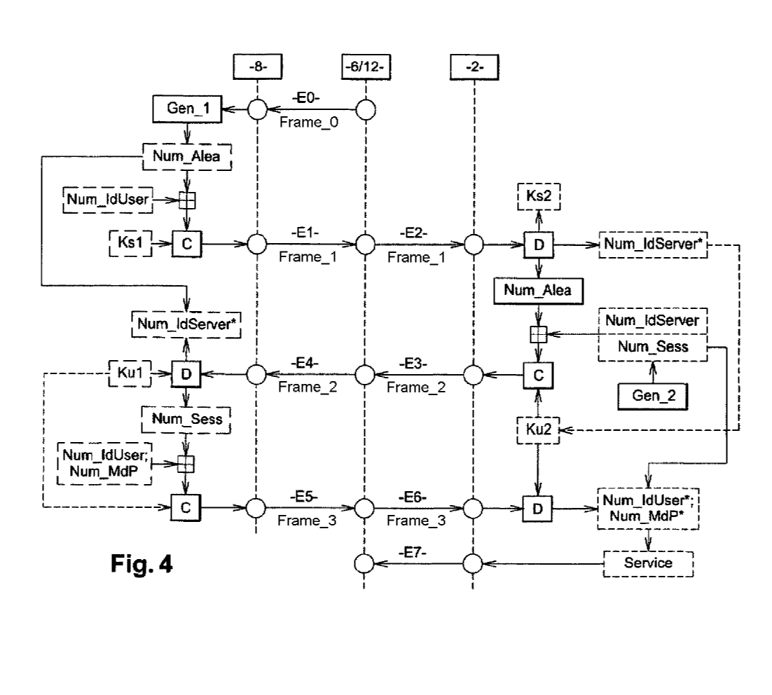

According to a third implementation of the method according to the invention, represented in FIG. 4, which corresponds to a refinement of the first implementation, the variant embodiment of the system comprising the means of generating a random sequence Num_Alea is used. It should be noted that we will note here the identification number of the user Num_IdUser and no longer num_ID to differentiate it from an identifier of the server 2 also used in this implementation of the method.

In a preliminary step E0, an initialization of a data exchange is requested by the user via the terminal 6, by sending a data frame Frame_0.

In a first step E1, a first phase of generating a random sequence Gen_1 is carried out by the hardware element 8 which makes it possible to determine a random sequence Num_Alea.

Then, the processing means of the hardware element 8 sign the identifier of the user Num_IdUser from the random sequence Num_Alea, concatenating the result of this signature with the random sequence Num_Alea, then produce an encryption C using its first private key Ks1, to obtain a data frame Frame_1, which can be represented by the following formula, in which the + sign represents a concatenation and the ̂ sign an Xor type operation:
Frame_1=C_{Ks1}(Num_Alea+Num_AleâNum_IdUser)

The frame Frame_1 is sent to the client software.

In a second step E2, the frame Frame_1 is transmitted to the server 2 in a session number request.

In a third step E3, the server 2 produces a decryption D of the frame Frame_1 using a first public key Ks2 corresponding to the private key Ks1 of the user, which enables it to obtain the values of the identifier of the user Num_IdUser and of the random sequence Num_Alea.

A test can then be carried out on the user's identifier.

The server 2 also generates Gen_2 a session number Num_Sess.

The server 2 then signs the random sequence Num_Alea and an identifier of the server Num_IdServer with the session number Num_Sess, then encrypts these two concatenated signature results using a second public key Ku2, to obtain a data frame Frame_2:
Frame_2=C_{Ku2}(Num_AleâNum_Sess+Num_SesŝNum_IdServer)

The frame Frame_2 is then sent to the client software 12.

In a fourth step E4, the user's computer transmits the frame Frame_2 to the hardware element 8.

In a fifth step E5, the processing means 10 of the hardware element 8 produce a decryption D of the frame Frame_2 using a second private key Ku1 corresponding to the public key Ku2 of the server, which enables it to obtain the values of the server identifier Num_IdServer and of the session number Num_Sess and a value returned by the server of the random sequence Num_Alea.

A test can then be carried out on the identifier of the server 2 by also checking that the random sequence Num_Alea returned by the server corresponds to the one sent.

The processing means of the hardware element 8 then sign the identifier of the user Num_IdUser and the password Num_MDP using the session number Num_Sess, then encrypt these two concatenated signature results using the second private key Ku1, to obtain a data frame Frame_3:
Frame_3=C_{Ku1}(Num_SesŝNum_IdUser+Num_SesŝNum_MDP)

The frame Frame_3 is then sent to the client software 12.

In a sixth step E6, the client software 12 transmits the frame Frame_3 in turn to the server 2.

Once the password presentation protocol is complete, the server 2 produces a decryption D of the frame Frame_3 using the public key Ku2 corresponding to the private key Ku1 of the user, which enables it to obtain the values of the password Num_MDP and of the session number num_Sess, as well as the identifier of the user Num_IdUser.

The server 2 then compares the session number num_Sess with the one it has transmitted, then it carries out tests on the identifier Num_IdUser and the password Num_MDP to accept or reject the identification of the user.

If the identification is accepted, the requested service can then be supplied by the server in a seventh step E7.

The system thus mutually authenticates the server and the user before transmitting the critical data. This system has been designed to address the current problems faced by Internet users. Thus, the hardware element 8 has the capacity to determine the recipient the password is sent to.

For this, the hardware element 8 challenges the server, in order to determine whether it is connected to a determined server. The hardware element 8 can then alert the user, for example via a diode, if the latter is connected to a server that has spoofed the identity of the site.

These provisions are enhanced through the use of random number or sequence generation means in the hardware element 8.

Without random generation in the hardware element 8, it is possible to send messages to the key in order to obtain information likely to compromise the security of the secret or private keys stored in this hardware element 8.

A “pirate” element trying to replay a frame Frame_1, will have to be capable of responding to the challenge from the server without being able to use the hardware element 8.

The frame Frame_2 includes the use of the random number generated by the hardware element 8 which makes it possible to check the identity of the server and thus permit a response to the latter.

The method can be implemented in such a way as to run in full before notifying the user as to whether or not he has been authenticated. If an erroneous frame is received, the system will respond with a false frame that will be subjected to the same processing until the protocol is finished. This is done in order to give the minimum of information to a “pirate” element to compromise the security of the system.

The link between the number that identifies the user Num_IdUser and his identity is produced on the server. Thus, there is no need to transmit a critical element such as the user's credit card number to be able to use the system.

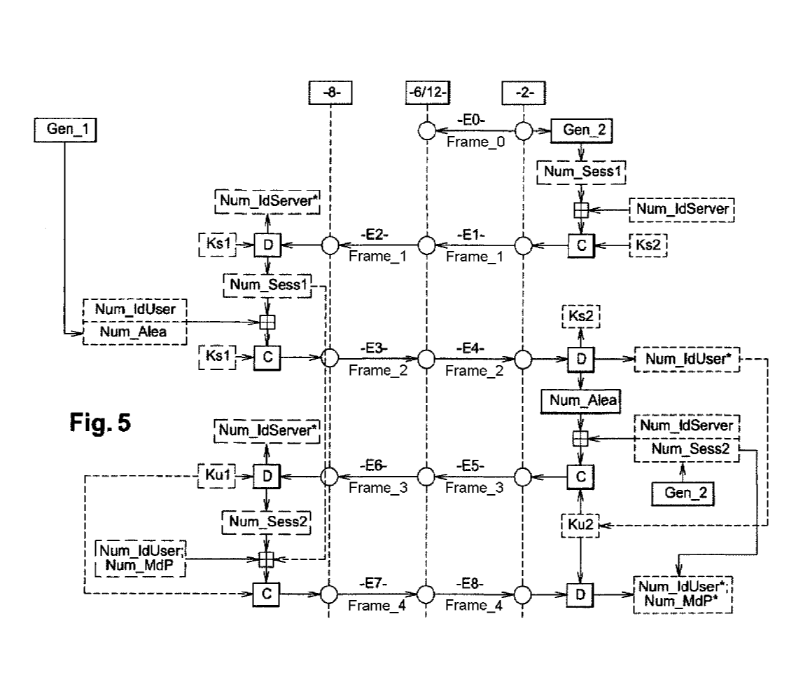

According to a fourth implementation of the method according to the invention, represented in FIG. 5, which corresponds to a refinement of the second implementation, the variant embodiment of the system comprising means of generating a random sequence Num_Alea is used.

In a preliminary step E0, an initialization of a data exchange is requested by the user via the terminal 6, by sending a data frame Frame_0 to the server 2.

In a first step E1, the server 2 generates Gen_2 a first session number Num_Sess1.

The server 2 then signs the identifier of the server Num_IdServer with the first session number Num_Sess1, then concatenates the identifier of the server with the result of the signature, and encrypts this concatenated data with a first public key Ks2, to obtain a data frame Frame_1:

Frame_1=C_{Ks2}(Num_Sess1+Num_Sess1̂Num_IdServer)

The frame Frame_1 is then sent to the client software 12.

In a second step E2, the user's computer transmits the frame Frame_1 to the hardware element 8.

In a third step E3, the processing means 10 of the hardware element 8 produce a decryption D of the frame Frame_1 using a first private key Ks1 corresponding to the public key Ks2 of the server, which enables it to obtain the values of server identifier Num_IdServer and of the first session number Num_Sess1.

A test can then be carried out on the identifier of the server 2.

The processing means 10 of the hardware element 8 carry out a phase for generation of a random sequence Gen_1 which makes it possible to determine a random sequence Num_Alea.

Then, the processing means of the hardware element 8 sign the first session number Num_Sess1 with the random sequence Num_Alea and the identifier of the user Num_IdUser with the random sequence Num_Alea, then concatenate the result of these two signatures, then produce an encryption C using its first private key Ks1, to obtain a data frame Frame_2:

Frame_2=C_{Ks1}(Num_Sess1̂Num_Alea+Num_AleâNum_IdUser)

The frame Frame_2 is sent to the client software.

In a fourth step E4, the frame Frame_2 is transmitted to the server 2.

In a fifth step E5, the server 2 produces a decryption D of the frame Frame_2 using the first public key Ks2 corresponding to the private key Ks1 of the user, which enables it to obtain the values of the user identifier Num_IdUser and of the random sequence Num_Alea.

A test can then be carried out on the identifier of the user.

The server 2 then generates Gen_2 a second session number Num_Sess2.

The server 2 then signs the random sequence Num_Alea and an identifier of the server Num_IdServer with the second session number Num_Sess2, then encrypts these two concatenated signature results with a second public key Ku2, to obtain a data frame Frame_3:

Frame_3=C_{Ku2}(Num_AleâNum_Sess2+Num_Sess2̂Num_IdServer)

The frame Frame_3 is then sent to the client software 12.

In a sixth step E6, the user's computer transmits the frame Frame_3 to the hardware element 8.

In a seventh step E7, the processing means 10 of the hardware element 8 produce a decryption D of the frame Frame_3 using a second private key Ku1 corresponding to the public key Ku2 of the server, which enables it to obtain the values of the server identifier Num_IdServer and of the second session number Num_Sess2 and a value, returned by the server, of the random sequence Num_Alea.

A test can then be carried out on the identifier of the server 2 by also checking that the random sequence Num_Alea returned by the server corresponds to the one sent.

The processing means of the hardware element 8 then sign the identifier of the user Num_IdUser with the first session number Num_Sess1 and the password Num_MDP with the second session number Num_Sess2, then encrypt these two concatenated signature results with the second private key Ku1, to obtain a data frame Frame_4:

Frame_4=C_{Ku1}(NumSess1̂Num_IdUser+Num_Sess2̂Num_MdP)

The frame Frame_4 is then sent to the client software 12.

In an eighth step E8, the client software 12 transmits the frame Frame_4 in turn to the server 2.

Once the password presentation protocol is complete, the server 2 produces a decryption D of the frame Frame_4 using the public key Ku2 corresponding to the private key Ku1 of the user, which enables it to obtain the values of the password Num_MDP and of the session numbers Num_Sess1 and Num_Sess2, as well as the identifier of the user Num_IdUser.

The server 2 then compares the session numbers Num_Sess1 and Num_Sess2 with those which it has transmitted, then it carries out tests on the identifier Num_IdUser and the password Num_MDP to accept or reject the identification of the user.

If the identification is accepted, the requested service can then be supplied by the server in a ninth step which is not represented.

It should be noted that it is possible to carry out exchanges comprising multiple random sequence or session number generations in order to further secure the system.

In these conditions, the frames could be defined as follows:

$$Frame\_ 1 = {C}_{K s 1} [ Num\_Alea \_ 1 + Num\_Alea \_ 1 \hat{} Num\_IdUser ]$$

$$Frame\_ 2 = {C}_{Ku 2} [ \begin{matrix}Num\_Alea1 \hat{} Num\_Sess \_ 1 + \\ Num\_Sess \_ 1 \hat{} Num\_IdServer\end{matrix} ]$$

$$Frame\_ 3 = {C}_{Ku {1}^{′}} [ \begin{matrix}Num\_Sess \_ 1 \hat{} Num\_Alea \_ 2 + \\ Num\_Alea \_ 2 \hat{} Num\_IdUser\end{matrix} ]$$

$$…$$

$$Frame\_ 2 n = {C}_{Ku {2}^{″}} [ \begin{matrix}Num\_Alea \_n \hat{} Num\_Sess \_n + \\ Num\_Sess \_n \hat{} Num\_IdServer\end{matrix} ]$$

$$Frame\_ 2 n + 1 = {C}_{Ku {1}^{″}} [ \begin{matrix}Num\_Sess \_n \hat{} Num\_Alea \_n + 1 + \\ Num\_Alea \_n + 1 \hat{} Num\_IdUser\end{matrix} ]$$

$$…$$

$$Frame\_ 2 f = {C}_{Ku {2}^{″}} [ \begin{matrix}Num\_Alea \_f \hat{} Num\_Sess \_f + \\ Num\_Sess \_f \hat{} Num\_IdServer\end{matrix} ]$$

$$Frame\_finale ( 2 f + 1 ) = {C}_{Ku {{{1}^{′}}^{′}}^{′}} [ \begin{matrix}Num\_Sess \_f \hat{} Num\_IdUser * + \\ Num\_Sess \_f \hat{} Num\_MdP\end{matrix} ]$$

The frames could also be defined in this other way:

$$Frame\_ 1 = {C}_{Ks 2} [ Num\_Sess \_ 1 + Num\_Sess \_ 1 \hat{} Num\_IdServer ]$$

$$Frame\_ 2 = {C}_{K s 1} [ \begin{matrix}Num\_Sess \_ 1 \hat{} Num\_Alea \_ 1 + \\ Num\_Alea \_ 1 \hat{} Num\_IdUser\end{matrix} ]$$

$$Frame\_ 3 = {C}_{Ku {2}^{′}} [ \begin{matrix}Num\_Alea \_ 1 \hat{} Num\_Sess \_ 2 + \\ Num\_Sess \_ 2 \hat{} Num\_IdServer\end{matrix} ]$$

$$Frame\_ 4 = {C}_{Ku {1}^{′}} [ \begin{matrix}Num\_Sess \_ 2 \hat{} Num\_Alea \_ 2 + \\ Num\_alea \_ 2 \hat{} Num\_IdUser\end{matrix} ]$$

$$…$$

$$Frame\_ 2 n - 1 = {C}_{Ku {2}^{″}} [ \begin{matrix}Num\_Alea \_n - 1 \hat{} Num\_Sess \_n + \\ Num\_Sess \_n \hat{} Num\_IdServer\end{matrix} ]$$

$$Frame\_ 2 n = {C}_{Ku {1}^{″}} [ \begin{matrix}Num\_Sess \_n \hat{} Num\_Alea \_n + 1 + \\ Num\_alea \_n + 1 \hat{} Num\_IdUser\end{matrix} ]$$

$$…$$

$$Frame\_ 2 f - 1 = {C}_{Ku {2}^{″}} [ \begin{matrix}Num\_Alea \_f - 1 \hat{} Num\_Sess \_f + \\ Num\_Sess \_f \hat{} Num\_IdServer\end{matrix} ]$$

$$Frame\_finale ( 2 f ) = {C}_{K u {{{1}^{′}}^{′}}^{′}} [ \begin{matrix}Num\_Sess \_f \hat{} Num\_IdUser * + \\ Num\_Sess \_f \hat{} Num\_MdP\end{matrix} ]$$

According to variants, the session number num_Sess can be the result of a function, a date or the combination of both. This combination can be checked by the hardware element before a password is presented. The hardware element can ask the application server to prove its identity in the same way.

According to another variant, the password num_MDP can be requested from the user by the client software 12, to be signed and transmitted to the server 2.

In another variant, a random number can be added to the calculation of the signed password in order to fend off exhaustive attacks (by salting). This random number can be calculated by applying a one-way function to a number. Since the result of this operation is then used to calculate the next random number, the one-way function is thus used recursively.

According to another variant, the combination of the password and of the session number in the hardware element can be produced, not by concatenation, but, for example, by bit-by-bit addition. The server, which also knows the session number, can subtract the latter from the combination to deduce the password therefrom.

According to another variant, the user's password is not stored in the hardware element, but input by the user via terminal input means.

The system and the method according to the invention can notably be applied to avoid identity theft from an Internet site or a service, the aim of such theft being to obtain a user's confidential identification data. These thefts notably correspond to the practices known as phishing or pharming.

Another application is the fight against fraudulent purchase validations by bank card identification numbers without inputting the confidential code, by a person other than the card holder.

It goes without saying that the invention is not limited to the single embodiment of the system that is described hereinabove by way of example, but, on the contrary, encompasses all the variants.

1. An information system comprising:
a computer server comprising networked communication means,
at least one terminal comprising networked communication means, the terminal being intended to be used by a user to set up a connection to the server,
a hardware element arranged to be connected to the terminal, the hardware element comprising data storage means arranged to store an encryption key and an identification number,
wherein the server is arranged to generate a unique session number in the course of a connection session between the terminal and the server, and to communicate the session number to the terminal, the terminal being arranged to communicate the session number to the hardware element
wherein the hardware element comprises processing means arranged to produce an encryption using an encryption key for a data set combining:
a password of the user, and
the session number,
and arranged to transmit the result of the encryption forming an encrypted password and the identification number to the terminal, the terminal being arranged to transmit the encrypted password and the identification number to the server in order to identify the user.

2. The system as claimed in claim 1, wherein the password is stored on the data storage means of the hardware element.

3. The system as claimed in claim 1, wherein the terminal comprises means of inputting the password by the user and is arranged to communicate the password to the hardware element.

4. The system as claimed in claim 1, wherein the server is arranged to communicate a unique session number in response to the provision of an identification number by the hardware element.

5. The system as claimed in claim 1, wherein the server is arranged to produce an encryption by an encryption key of the session number into an encrypted session number and to communicate the encrypted session number to the terminal, the terminal being arranged to communicate the encrypted session number to the hardware element, the processing means of the hardware element being arranged to produce a decryption of the encrypted session number into a session number by the encryption key stored in the storage means.

6. The system as claimed in claim 1, wherein the server is arranged to produce a decryption of the encrypted password using a decryption key corresponding to the encryption key stored in the storage means of the hardware element, to obtain the values of the password and of the session number.

7. The system as claimed in claim 6, wherein the server is arranged to compare the session number originating from the encrypted password with that which it has generated, then to compare the result of the application of a hashing function to a data combination comprising the password with a predetermined value.

8. The system as claimed in claim 1, wherein the password and the identification number form a unique information pair in the system.

9. The system as claimed in claim 1, wherein the hardware element comprises means of generating a random sequence, the processing means being arranged to produce a first encryption of a data set combining:
the random sequence, and
the identification number of the user,
and arranged to transmit a first data frame comprising the result of the first encryption to the terminal, the terminal being arranged to transmit this first data frame to the server,
wherein the server is arranged to produce decryption of the first data frame then a second encryption of a data set combining:
the random sequence, and
a session number, and
an identification number of the server
and to transmit a second data frame comprising the result of this second encryption to the terminal, the terminal being arranged to transmit this second data frame to the hardware element.

10. The system as claimed in claim 9, wherein two pairs of private keys and public keys are used respectively for the encryption and the decryption of a first and a second data exchange between the server and the hardware element.

11. The system as claimed in claim 9, wherein a number of random sequences and/or a number of session numbers are generated by the hardware element or the server for successive data exchanges to identify a user.

12. The system as claimed in claim 8, wherein the means of generating a random sequence of the hardware element are arranged to take account of the occurrence of a random event.

13. The system as claimed in claim 12, wherein the random events taken into account by the random sequence generation means comprise interrupts signaling arrival of new information at the hardware element originating from the terminal.

14. A method of identifying, by a computer server, a user in possession of a terminal having communication means to set up a connection between the server and the terminal, and a hardware element, connected to the terminal, comprising data storage means on which are stored an encryption key and an identification number, wherein
the server generates a unique session number in the course of a connection session between the terminal and the server,
the terminal communicates the session number to the hardware element,
the hardware element produces an encryption using an encryption key of a data set combining the password and the session number, and communicates the result of the encryption to the terminal,
the hardware element also transmits the identification number to the terminal,
the terminal transmits the result of the encryption and the identification number to the server in order to identify the user.

15. The method as claimed in claim 14, wherein the password is stored on the data storage means of the hardware element.

16. The method as claimed in claim 14, wherein the password is input by the user on the terminal and communicated to the hardware element by the terminal.

17. The method as claimed in claim 14, wherein the server communicates a unique session number in response to the provision of an identification number by the hardware element.

18. The method as claimed in claim 14, wherein the server produces an encryption by an encryption key of the session number into an encrypted session number and communicates the encrypted session number to the terminal, the terminal communicating the encrypted session number to the hardware element, the processing means of the hardware element producing a decryption of the encrypted session number into a session number by the encryption key stored in the storage means.

19. The method as claimed in one claim 1, wherein the server produces a decryption of the encrypted password using a decryption key corresponding to the encryption key stored in the storage means of the hardware element, to obtain the values of the password and of the session number.

20. The method as claimed in claim 19, wherein the server compares the session number originating from the encrypted password with that which it has generated, then compares the result of the application of a hashing function to a data combination comprising the password with a predetermined number.

21. The method as claimed in claim 14, wherein the password and the identification number form a unique information pair.

22. The method as claimed in claim 14, wherein the hardware element generates a random sequence, produces a first encryption of a data set combining:
the random sequence, and
the identification number of the user,
and transmits a first data frame corresponding to the result of the encryption to the terminal which transmits this first data frame to the server,
the server producing a decryption of the first data frame then a second encryption of a data set combining:
the random sequence, and
a session number, and
an identification number of the server
and transmitting a second data frame corresponding to the result of this second encryption (Frame 2, Frame 3) to the terminal, the terminal transmitting this second data frame (Frame 2, Frame 3) to the hardware element.

23. The method as claimed in claim 22, wherein two pairs of private keys and public keys are used respectively for the encryption and the decryption of a first and a second data exchange between the server and the hardware element.

24. The method as claimed in claim 22, wherein a number of random sequences and/or a number of session numbers are generated for successive data exchanges to identify a user.

25. The method as claimed in claim 22, wherein the generation of a random sequence takes account of the occurrence of a random event.

26. The method as claimed in claim 25, wherein the random events taken into account when generating random sequences comprise interrupts signaling the arrival of new information at the hardware element originating from the terminal.

27. The method as claimed in claim 22, wherein at least one data frame exchanged between the hardware element and the terminal comprises both a random sequence generated by the hardware element and a session number generated by the server.
